(19) United States
(12) Patent Application Publication
(10) Pub. No.: US 2013/0011693 A1
(43) Pub. Date: Jan. 10, 2013

(54) METAL COATED STEEL STRIP

(75) Inventors: Ross McDowall Smith, Cordeaux Heights (AU); Qiyang Liu, Mount Keira (AU); Joe Williams, Woonona (AU); Aaron Kiffer Neufeld, Figtree (AU); Scott Robin Griffiths, Berkeley (AU)

(73) Assignee: BLUESCOPE STEEL LIMITED, Melbourne, Victoria (AU)

(21) Appl. No.: 13/520,643

(22) PCT Filed: Jan. 6, 2011
(86) PCT No.: PCT/AU2011/000010

§ 371 Date: Sep. 24, 2012

(30) Foreign Application Priority Data
Jan. 6, 2010 (AU) 2010900043

(51) Int. Cl. B32B 15/01

(52) U.S. Cl. 428/650

(57) ABSTRACT

A steel strip that has a coating of an Al—Zn—Si alloy that contains 0.3-10 wt. % Mg and 0.005-0.2 wt. % V.

The present invention relates to strip, typically steel strip, which has a corrosion-resistant metal alloy coating of an alloy that contains aluminium, zinc, and silicon and is hereinafter referred to as an “Al—Zn—Si alloy” on this basis.

The present invention relates particularly but not exclusively to a corrosion-resistant metal alloy coating that contains aluminium, zinc, silicon, and magnesium as the main elements in the alloy coating and is hereinafter referred to as an “Al—Zn—Si Mg alloy” on this basis. The alloy coating may contain other elements that are present as deliberate alloying additions or as unavoidable impurities.

The present invention relates particularly but not exclusively to steel strip that is coated with the above-described Al—Zn—Si—Mg alloy and can be cold formed (e.g. by roll forming) into an end-use product, such as roofing products.

Typically, the Al—Zn—Si—Mg alloy of the present invention comprises the following ranges in % by weight of the elements Al, Zn, Si, and Mg:

Al: 40 to 60%

Zn: 30 to 60%

Si: 0.3 to 3%

Mg: 0.3 to 10%.

More typically, the Al—Zn—Si—Mg alloy of the present invention comprises the following ranges in % by weight of the elements Al, Zn, Si, and Mg:

Al: 45 to 60%

Zn: 35 to 50%

Si: 1.2 to 2.5%

Mg 1.0 to 3.0%.

Depending on the end-use application, the metal-coated strip may be painted, for example with a polymeric paint, on one or both surfaces of the strip. In this regard, the metal-coated strip may be sold as an end product itself or may have a paint coating applied to one or both surfaces and be sold as a painted end product.

The present invention relates particularly but not exclusively to steel strip that is coated with the above-described Al—Zn—Si—Mg alloy and is optionally coated with a paint and thereafter is cold formed (e.g. by roll forming) into an end-use product, such as building products (e.g. profiled wall and roofing sheets).

The present invention relates particularly but not exclusively to a cold formed (e.g. roll formed) end-use product (e.g. profiled wall and roofing sheet) comprising steel strip that is coated with the above-described Al—Zn—Si—Mg alloy and is optionally coated with a paint.

Typically, the corrosion-resistant metal alloy coating is formed on steel strip by a hot dip coating method.

In the conventional hot-dip metal coating method, steel strip generally passes through one or more heat treatment furnaces and thereafter into and through a bath of molten metal alloy held in a coating pot.

The metal alloy is usually maintained molten in the coating pot by the use of heating inductors. The strip usually exits the heat treatment furnaces via an outlet end section in the form of an elongated furnace exit chute or snout that dips into the bath. Within the bath the strip passes around one or more sink rolls and is taken upwardly out of the bath and is coated with the metal alloy as it passes through the bath.

After leaving the coating bath the metal alloy coated strip passes through a coating thickness control station, such as a gas knife or gas wiping station, at which its coated surfaces are subjected to jets of wiping gas to control the thickness of the coating.

The metal alloy coated strip then passes through a cooling section and is subjected to forced cooling.

The cooled metal alloy coated strip may thereafter be optionally conditioned by passing the coated strip successively through a skin pass rolling section (also known as a temper rolling section) and a tension levelling section. The conditioned strip is coiled at a coiling station.

The aluminium and zinc are provided in an Al—Zn—Si alloy coating on a steel strip for corrosion resistance.

The aluminium, zinc, and magnesium are provided in an Al—Zn—Si alloy coating on a steel strip for corrosion resistance.

The silicon is provided in both alloy types to prevent excessive alloying between a steel strip and the molten coating in the hot-dip coating method. A portion of the silicon takes part in a quaternary alloy layer formation but the majority of the silicon precipitates as needle-like, pure silicon particles during solidification. These needle-like silicon particles are also present in the inter-dendritic regions of the coating.

One corrosion resistant metal coating composition that has been used widely in Australia and elsewhere for building products, particularly profiled wall and roofing sheets, for a considerable number of years is an Al—Zn—Si alloy composition comprising 55% Al. The profiled sheets are usually manufactured by cold forming painted, metal alloy coated strip. Typically, the profiled sheets are manufactured by roll-forming the painted strip.

The addition of Mg to this known composition of 55% Al—Zn—Si coating composition has been proposed in the patent literature for a number of years, see for example U.S. Pat. No. 6,635,359 in the name of Nippon Steel Corporation. However, Al—Zn—Si—Mg alloy coatings on steel strip are not commercially available in Australia.

The above description is not to be taken as an admission of the common general knowledge in Australia or elsewhere.

It has been found by the applicant that magnesium and vanadium enhance specific aspects of corrosion performance of 55% Al—Zn—Si alloy metallic coated steel strip.

In particular, it has been found by the applicant that when Mg is included in a 55% Al—Zn—Si coating composition, it brings about certain beneficial effects on product performance, such as improved cut-edge protection, by changing the nature of corrosion products formed in both marine and acid rain environments. This improvement in corrosion performance has been demonstrated by research work carried out by the applicant including comprehensive accelerated corrosion testing and outdoor exposure testing carried out by the applicant. For magnesium additions, the improvement in the level of edge undercutting for metallic coated steel with a paint coating is more pronounced than the improvement in bare surface corrosion of the metallic coating in marine environments.

It has also been found by the applicant that when V is included in Al—Zn—Si alloy coating compositions, the V brings about certain beneficial effects on product performance. The applicant has found that the level of mass loss from bare (unpainted) metallic coated steel strip surfaces tested on outdoor exposure is reduced by an average of 33% for a range of environments. As distinct from magnesium, the improvement in coating loss from bare (unpainted) surfaces is much greater than improvements in the level of edge undercutting for metallic coated steel strip with a paint coating.

The present invention is a metal, typically steel, strip that has a coating of an Al—Zn—Si alloy that contains 0.3-10 wt. % Mg and 0.005-0.2 wt. % V in order to take advantage of the above-mentioned complementary aspects of corrosion performance of the coating.

More particularly, the addition of the Mg and the V improves both the bare mass loss of the strip and the edge undercutting of painted, metallic coated strip to a level that is greater than could be obtained by larger separate additions of each respective element alone.

The coating alloy may be an Al—Zn—Si—Mg alloy that comprises the following ranges in % by weight of the elements Al, Zn, Si, and Mg:

Al: 40 to 60%

Zn: 30 to 60%

Si: 0.3 to 3%

Mg: 0.3 to 10%

The coating alloy may be an Al—Zn—Si—Mg alloy that comprises the following ranges in % by weight of the elements Al, Zn, Si, and Mg:

Al: 45 to 60%

Zn: 35 to 50%

Si: 1.2 to 2.5%

Mg 1.0 to 3.0%.

The coating alloy may contain less than 0.15 wt. % V.

The coating alloy may contain less than 0.1 wt. % V.

The coating alloy may contain at least 0.01 wt. % V.

The coating alloy may contain at least 0.03 wt. % V.

The coating alloy may contain other elements.

The other elements may be present as unavoidable impurities and/or as deliberate alloy additions.

By way of example, the coating alloy may contain any one or more of Fe, Cr, Mn, Sr, and Ca.

The coating may be a single layer as opposed to multiple layers.

The coating may be a coating that does not include a non-equilibrium phase.

The coating may be a coating that does not include an amorphous phase.

The coated metal strip may have a paint coating on an outer surface of the alloy coating.

The present invention is also a cold formed (e.g. roll formed) end-use product (e.g. profiled wall and roofing sheet) comprising steel strip that is coated with the above-described coating alloy and is optionally coated with a paint.

The present invention is described further by way of example with reference to the accompanying drawings, of which:

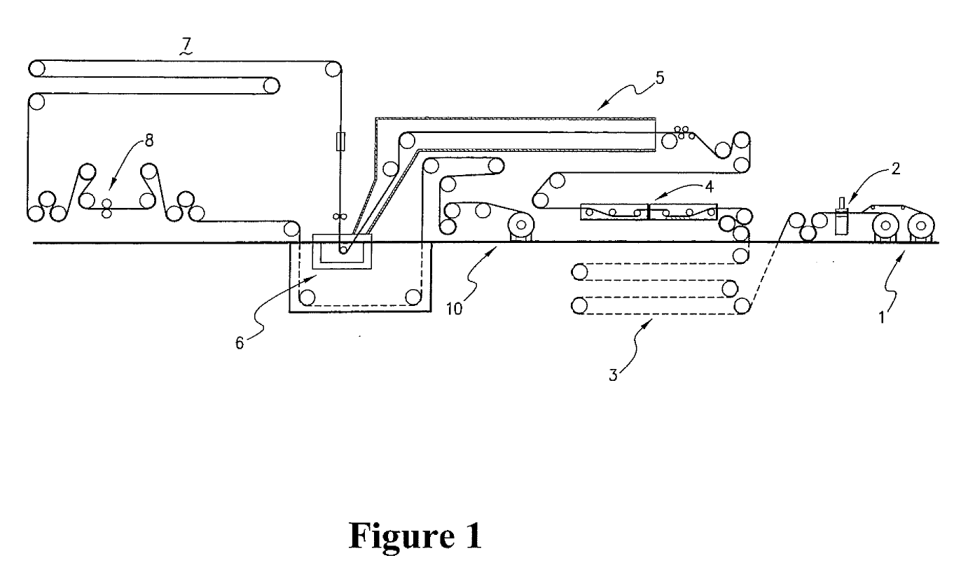

FIG. 1 is a schematic drawing of one embodiment of a continuous production line for producing steel strip coated with an Al—Zn—Si—Mg alloy in accordance with the method of the present invention; and

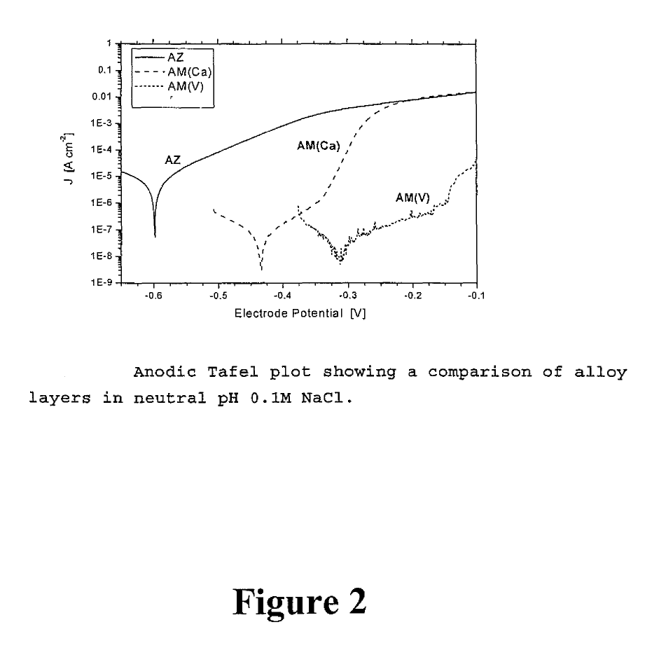

FIG. 2 is an Anodic Tafel plot showing a comparison of coating alloys, including an embodiment of an alloy coating in accordance with the present invention.

With reference to FIG. 1, in use, coils of cold rolled steel strip are uncoiled at an uncoiling station 1 and successive uncoiled lengths of strip are welded end to end by a welder 2 and form a continuous length of strip.

The strip is then passed successively through an accumulator 3, a strip cleaning section 4 and a furnace assembly 5. The furnace assembly 5 includes a preheater, a preheat reducing furnace, and a reducing furnace.

The strip is heat treated in the furnace assembly 5 by careful control of process variables including:(i) the temperature profile in the furnaces, (ii) the reducing gas concentration in the furnaces, (iii) the gas flow rate through the furnaces, and (iv) strip residence time in the furnaces (i.e. line speed).

The process variables in the furnace assembly 5 are controlled so that there is removal of iron oxide residues from the surface of the strip and removal of residual oils and iron fines from the surface of the strip.

The heat treated strip is then passed via an outlet snout downwardly into and through a molten bath containing an Al—Zn—Si—Mg alloy held in a coating pot 6 and is coated with Al—Zn—Si—Mg alloy. The Al—Zn—Si—Mg alloy is maintained molten in the coating pot by use of heating inductors (not shown). Within the bath the strip passes around a sink roll and is taken upwardly out of the bath. Both surfaces of the strip are coated with the Al—Zn—Si—Mg alloy as it passes through the bath.

After leaving the coating bath 6 the strip passes vertically through a gas wiping station (not shown) at which its coated surfaces are subjected to jets of wiping gas to control the thickness of the coating.

The coated strip is then passed through a cooling section 7 and subjected to forced cooling.

The cooled, coated strip is then passed through a rolling section 8 that conditions the surface of the coated strip.

The coated strip is thereafter coiled at a coiling station 10.

As is indicated above, the present invention is based on research work carried out by the applicant on the known 55% Al—Zn—Si alloy coating on steel strip which found that magnesium and vanadium enhance specific aspects of corrosion performance of the coated steel strip.

The research work included accelerated corrosion testing and outdoor exposure testing in acidic and marine environments for extended time periods.

The Anodic Tafel plot in FIG. 2 illustrates the results of a part of the research work. The plot shows the logarithm of the current density (“J”—in A/cm²) against the electrode potential (in Volts) for 3 alloy compositions. The plot shows the results of research work on coatings of (a) the known 55% Al—Zn—Si alloy (“AZ”), (b) an Al—Zn—Si—Zn alloy containing Ca (“AM(Ca)”), and (c) an Al—Zn—Si—Zn alloy containing V in accordance with one embodiment of the present invention (“AM(V)”).

The plot of FIG. 2 compares the corrosion performance of the alloy coatings (a), (b), and (c). The plot and other results obtained by the applicant indicate that:

(a) the AM(V) alloy coating of the present invention had a lower corrosion current at a given corrosion potential than the other alloy coatings (1.5-2 times improvement of AM(V) over AM(Ca));

(b) the AM(V) alloy coating of the present invention had more noble corrosion potential compared to AM(Ca) (+0.03 V and +0.11 V respectively);

(c) the AM(V) alloy coating of the present invention had more noble pitting potential compared to AM(Ca) (+0.04 V and +0.18 V respectively); and

(d) the AM(V) alloy coating of the present invention had significantly lower oxidative current under anodic polarisation—compared to AM(Ca), at −0.25 V, the oxidative current is about 20000 times less for AM(V).

These improvements in the resistance for anodic dissolution of the alloy layer imply that upon exposure of the alloy coating of the present invention to corrodants (salt, acid, and dissolved oxygen) the metallurgical phase will corrode at a slow rate and the mode of corrosion will be generalised and less prone to localised and pitting corrosion mode. These properties will impart a longer life in an end-use product, as it will be rendered less likely to red rust staining, metal coating blistering and substrate perforation.

Many modifications may be made to the present invention as described above without departing from the spirit and scope of the invention.

1-10. (canceled)

11. A metal strip that has a coating of an Al—Zn—Si alloy that contains 0.3-10 wt. % Mg and 0.01-0.2 wt. % V.

12. The metal strip defined in claim 11 wherein the coating alloy is an Al—Zn—Si—Mg alloy that comprises the following ranges in % by weight of the elements Al, Zn, Si, and Mg:
Al: 40 to 60%
Zn: 30 to 60%
Si: 0.3 to 3%
Mg: 0.3 to 10%

13. The metal strip defined in claim 11 wherein the coating alloy is an Al—Zn—Si—Mg alloy that comprises the following ranges in % by weight of the elements Al, Zn, Si, and Mg:
Al: 45 to 60%
Zn: 35 to 50%
Si: 1.2 to 2.5%
Mg 1.0 to 3.0%.

14. The metal strip defined in claim 11 wherein the alloy coating contains less than 0.15 wt. % V.

15. The metal strip defined in claim 11 wherein the alloy coating contains less than 0.1 wt. % V.

16. The metal strip defined in claim 11 wherein the alloy coating contains at least 0.03 wt. % V.

17. The metal strip defined in claim 11 wherein the alloy coating contains other elements present as unavoidable impurities and/or as deliberate alloy additions.

18. The metal strip defined in claim 11 wherein the alloy coating is a single layer.

19. A cold formed end-use product comprising the metal strip defined in claim 11.
